(19) United States
(12) Patent Application Publication
(10) Pub. No.: US 2006/0176590 A1
(43) Pub. Date: Aug. 10, 2006

(54) Mirror for a vehicle

(76) Inventor: Barry Keane-Cartledge, Melton VIC (AU)

Correspondence Address: NEIFELD IP LAW, PC, 4813-B EISENHOWER AVENUE, ALEXANDRIA, VA, 22304, US

(21) Appl. No.: 11/346,248

(22) Filed: Feb. 3, 2006

(30) Foreign Application Priority Data
Feb. 7, 2005 (AU) 2005900529
Feb. 10, 2005 (AU) 2005900613
Jun. 9, 2005 (AU) 20055903000

(51) Int. Cl. G02B 5/08

(52) U.S. Cl. 359/857; 359/821

(57) ABSTRACT

The present invention provides a forward vision mirror for providing a generally forward view to a driver of a vehicle. The vehicle has a rear vision mirror and the forward vision mirror comprises a reflective element and a first holder portion arranged for holding the reflective element. The first holder portion has a first attachment surface. The forward vision mirror also comprises a second holder portion which has second and third attachment surfaces. The second holder portion is arranged for attachment to the first attachment surface of the first holder portion at the second attachment surface and for attachment to a surface of the vehicle at the third attachment surface in a manner such that the forward vision mirror faces in a forward direction of travel of the vehicle and is positioned in a field of view of the rear vision mirror.

### FIELD OF THE INVENTION

The present invention relates to a mirror for a vehicle.

### BACKGROUND OF THE INVENTION

Every driver has experienced the frustration of traveling behind a slower vehicle which blocks or impairs their forward view of an adjacent lane to the extent of compromising the safety of an overtaking maneuver. This is often the case when the slower vehicle is a truck or a four-wheel-drive vehicle. In order to safely overtake the slower vehicle, the driver must have good vision of traffic in the adjacent lane. This is most important when the adjacent lane carries vehicles traveling in an opposite, oncoming direction, in order to avoid a head on collision. However even on roads with multiple lanes where an adjacent lane carries vehicles traveling in the same direction, it is highly preferable that a driver have vision of vehicles in the adjacent lane in order to avoid a rear end collision. This may occur for example if vehicles in the adjacent lane forward of the driver have stopped or slowed considerably.

### SUMMARY OF THE INVENTION

The present invention provides in a first aspect a forward vision mirror for providing a generally forward view to a driver of a vehicle, the vehicle having a rear vision mirror, the forward vision mirror comprising:

a reflective element,

a first holder portion arranged for holding the reflective element, the first holder portion having a first attachment surface and

a second holder portion having second and third attachment surfaces, the second holder portion being arranged for attachment to the first attachment surface of the first holder portion at the second attachment surface and for attachment to a surface of the vehicle at the third attachment surface in a manner such that the forward vision mirror faces in a forward direction of travel of the vehicle and is positioned in a field of view of the rear vision mirror.

The forward vision mirror typically is arranged for mounting on an external surface of the vehicle. The second holder portion may be a solid or hollow portion and typically is a part that substantially fills or surrounds a region between the first attachment surface and the third attachment surface.

The forward vision mirror has the significant advantage that the first holder portion may be a universal part. For example, the first attachment surface of the first holder portion and also the second attachment surface of the second holder portion may have the same shape for any type of vehicle whereas the third attachment surface may have a shape that is vehicle specific or specific for a type of vehicles. The first holder portion typically protrudes more from the vehicle than the second holder portion and consequently it is more likely that the first holder portion is damaged of broken off in an accident. As the first holder portion may be a universal part that typically is not vehicle specific, repair is relatively uncomplicated and typically inexpensive. Further, the first holder portions may be interchangeable between forward vision mirrors that are arranged for mounting on a left external surface of the vehicle and forward vision mirrors that are arranged for mounting on a right external surface.

The first holder portion typically comprises a slot in which the reflective element is received. For example, the slot may be defined by substantially U-shaped regions of the first holder portion in which the reflective element is positioned. This slot typically has a practical advantage as it typically enables exchange of the reflective element in a relative simple manner.

The reflective element typically has an elongated shape. The forward vision mirror typically is arranged for mounting to the vehicle in a manner such that the direction of elongation is substantially vertical relative to the vehicle.

In one specific embodiment of the present invention the holder is a fixed holder that is not adjustable.

The present invention provides in a second aspect a vision system for a vehicle comprising:

a rear vision mirror providing a generally rearward field of view to a driver of the vehicle; and

the forward vision mirror according to the first aspect of the present invention.

The rear vision mirror typically is a first externally mounted rear vision mirror. The forward vision mirror typically is a first forward vision mirror and typically is externally mounted on the vehicle on a same side as the first externally mounted rear vision mirror.

The one specific embodiment the vision system further comprises a second externally mounted rear vision mirror providing a generally rearward field of view on an opposite side of the vehicle to the first externally mounted rear vision mirror; and,

a second externally mounted forward vision mirror for providing a generally forward view to a driver of a vehicle, the second forward vision mirror facing the forward direction of travel of the vehicle on an opposite side of the vehicle to the first externally mounted forward vision mirror, the second forward vision mirror being in the field of view of the second rear vision mirror.

The present invention provides in a third aspect a forward vision mirror for providing a generally forward view to a driver of a vehicle, the vehicle having a rear vision mirror and the forward vision mirror comprising:

a reflective element,

a holder for holding the reflective element in a manner such that the forward vision mirror faces in a forward direction of travel of the vehicle and is positioned in a field of view of the rear vision mirror,

wherein the reflective element has a height that is greater than its width when attached to the vehicle.

The forward vision mirror according to the third aspect of the present invention has the advantage that usually drives of differing height can view the forward direction without the need for prior adjustment when the drivers of differing height interchange.

The forward vision mirror typically is arranged for mounting on an external surface of the vehicle. The elongation of the mirror in the vertical direction has the advantage that the field of view in the forward direction may be relatively large while the forward vision mirror typically does not significantly protrude from the vehicle which increases safety and reduces risk of damaging the forward vision mirror.

In one specific embodiment of the present invention the holder is a fixed holder that is not adjustable.

The present invention provides in a fourth aspect a vision system for a vehicle comprising:

a rear vision mirror providing a generally rearward field of view to a driver of the vehicle; and

the forward vision mirror according to the third aspect of the present invention.

The rear vision mirror typically is a first externally mounted rear vision mirror. The forward vision mirror typically is a first forward vision mirror and typically is externally mounted on the vehicle on a same side as the first externally mounted rear vision mirror.

The one specific embodiment the vision system further comprises a second externally mounted rear vision mirror providing a generally rearward field of view on an opposite side of the vehicle to the first externally mounted rear vision mirror; and,

a second externally mounted forward vision mirror for providing a generally forward view to a driver of a vehicle, the second forward vision mirror facing the forward direction of travel of the vehicle on an opposite side of the vehicle to the first externally mounted forward vision mirror, the second forward vision mirror being in the field of view of the second rear vision mirror.

The present invention provides in a fifth aspect a vehicle comprising the vision system in accordance with the second or fourth aspect of the invention.

The forward vision mirror of the vehicle typically is sufficiently spaced from the rear vision mirror so that only a relatively small portion of the rear view of the rear vision mirror is obstructed by the forward vision mirror. The portion of the rear view that is obstructed typically is small enough so that the rear vision mirror provides a sufficiently large field of rear view. For example, the portion of the field of rear view that is obstructed by the forward vision mirror, as experienced by a driver of the vehicle, may be smaller than 50%, 40%, 30%, 20%, or even 10% of the field of rear view that the rear vision mirror would provide if the forward vision mirror would not be positioned in the field of rear view.

### BRIEF DESCRIPTION OF THE DRAWINGS

Embodiments of the present invention will now be described by way of example only with reference to the accompanying drawings in which:

FIG. 1 shows a side elevation of an embodiment of the forward vision mirror and method for providing a generally forward view of a road;

FIG. 2 shows a front elevation of the forward vision mirror;

FIG. 3 shows a top elevation of the forward vision mirror fitted to a vehicle;

FIG. 4 shows a top elevation of a further embodiment of the forward vision mirror fitted to a vehicle;

FIG. 5 shows a side elevation of a housing incorporated in the forward vision mirror;

FIG. 6 is a section view of the housing shown in FIG. 5;

FIG. 7(a) to (e) show side views of the forward vision mirror according to further embodiments of the present invention; and

FIG. 8(a) to (c) show views of the forward vision mirror according to other embodiments of the present invention.

### DETAILED DESCRIPTION OF SPECIFIC EMBODIMENTS

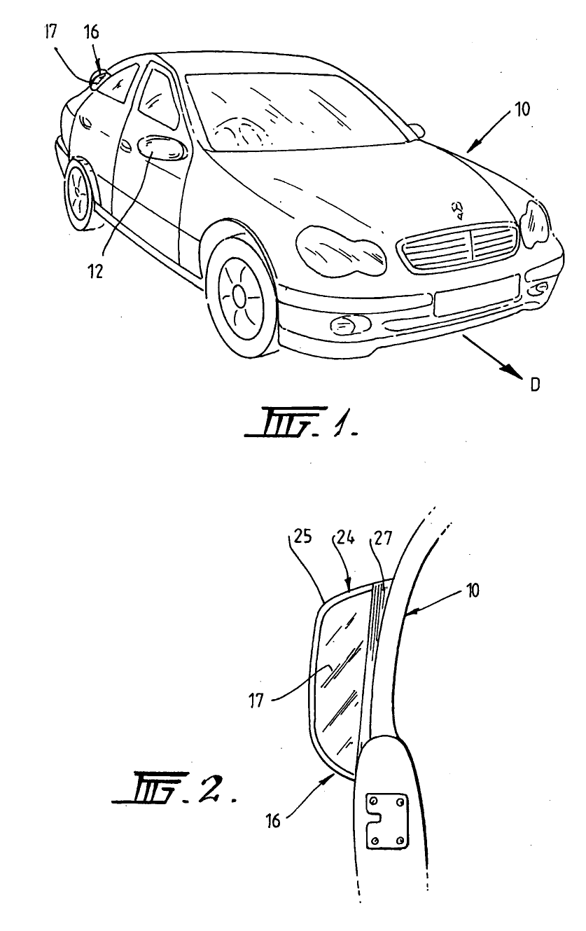

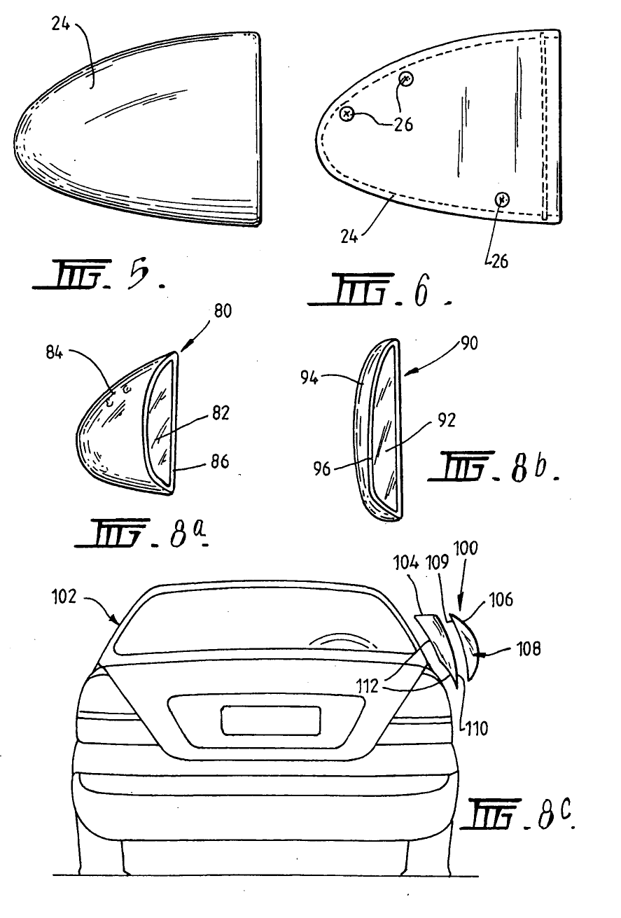

Referring initially to FIGS. 1-6, forward vision mirrors according to embodiments of the present invention are now described. The description is related to right hand steered vehicles used in countries where people drive on the left hand side of the road. However, it is to be understood that the present invention is independent of whether the vehicle is left hand drive or right hand drive and the driving position is on the left hand side or the right hand side.

The vehicle 10, a right hand drive vehicle, comprises a conventional rear vision mirror 12 mounted to a driver's side front door. The mirror 12 provides a general rearward field of view to a driver 14 of the vehicle 10 traveling in a forward direction D. A forward vision mirror 16 in accordance with an embodiment of the present invention is attached to the vehicle 10 and faces the forward direction D, the forward vision mirror 16 being juxtaposed to lie in the field of view of the rear vision mirror 12. Therefore a driver sitting in the vehicle 10 and looking in the rear vision mirror 12 is also able to see a reflection of traffic forward of the vehicle 10 in an adjacent lane. As the forward vision mirror 16 is spaced behind the rear vision mirror 12, only a relatively small portion of the rear view of the rear vision mirror 12 is obstructed by the forward vision mirror and the rear vision mirror 12 still has its original function of providing a rear view.

In this embodiment both the rear vision mirror 12 and forward vision mirror 16 are externally mounted to, and on the same side of, the vehicle 10. While this is the preferred configuration it may be possible with certain vehicles for the rear vision mirror to be the internal rear vision mirror. This is in essence dependent on geometry, as the forward vision mirror should be viewable in a rear vision mirror. In some vehicles the location of head-rests and various pillars and panels may enable the forward vision mirror 16 to be viewed from the internal rear vision mirror. Indeed in alternate embodiments a separate internal rear vision mirror may be provided for viewing the forward vision mirror 16.

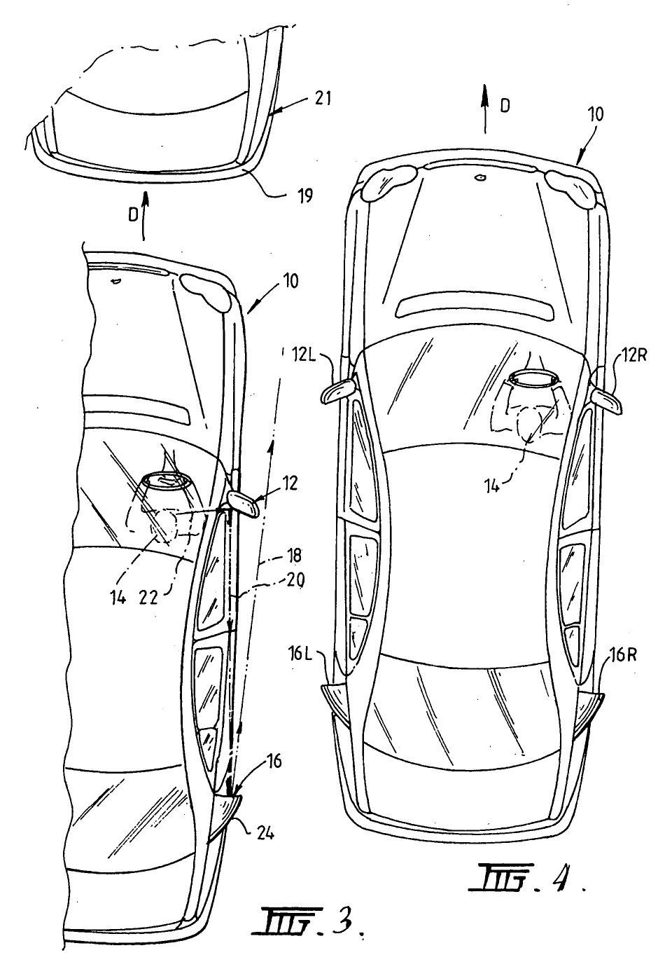

FIG. 3 shows a simple ray diagram of the optics involved in an embodiment of this invention applied to vehicle 10 behind a vehicle 17. The forward mirror 16, being forward facing, receives an incident ray 18 from a location forward and to the side of the vehicle 10 and the vehicle 17. The ray 18 is reflected off the mirror 16 to form ray 20 which impinges on the rear vision mirror 12. This ray is reflected on rear vision mirror 12 to form ray 22 impinging on the eye of the driver 16. Accordingly, by viewing in the rear vision mirror 12, the driver 14 is able to effectively see in the forward direction beyond or to the side of vehicle 19. This is particularly useful if the driver of a vehicle 10 wishes to over take vehicle 17 which is otherwise blocking the field of view in the forward direction D.

The use and operation of the forward vision mirror 16 is of course independent of the direction of traffic in a lane adjacent to the lane in which the vehicle 10 is traveling prior to conducting an over taking action. In the event that this lane contains on coming traffic then the forward vision mirror 16 provides forward vision for the purposes of minimising the risk of a head on collision. However if the traffic in the adjacent lane is traveling the same direction as vehicle.10 the operation of the forward vision mirror 16 minimises the risk of rear end collision.

It will be further apparent that the apparatus in accordance with embodiments of the present invention may comprise two forward vision mirrors 16L and 16R as shown in FIG. 4. The vehicle 10 also includes conventional exterior right hand rear vision mirror 12R and left hand rear vision mirror 12L. The provision of the forward vision mirror 16L on the left hand side of the vehicle in the field of view of rear vision mirror 12L provides the driver 16 with forward vision on the left hand side of the vehicle 10. This again is useful in minimizing the risk of a rear end collision in the event of overtaking on the left hand side of the vehicle, as for example, commonly occurs on multi lane roads.

Referring to FIG. 2, the forward vision mirror 16 comprises a holder or cowling 24 in which a reflective element 17 is disposed. The holder 24 is fixed to the vehicle 10, typically on the rear quarter panel extension which is between the rear door and the rear window of a sedan. The holder 24 can be made to any desired configuration and ideally would be shaped to match the styling of the vehicle 10 to which it is to be attached. In this embodiment the holder 24 comprises a first holder portion 25 and a second holder portion 27 which in this example is solid and fills the region between the vehicle and the first holder portion 25. It will be appreciated, however, that is variations of this embodiment the second holder portion 27 may be a hollow portion.

25 with reflective element 17 is in this embodiment a universal part that may be fitted to a variety of different vehicle types via a dedicated second holder portions 27. The second holder portion 27 has an attachment surface which is attached to the vehicle and which has a shape that corresponds to that of an external surface of the vehicle. The fixing of the holder 24 can be achieved by any known means including the use of studs, screws or bolts depicted generically as item 26 in FIG. 6.

In the embodiment shown FIG. 2 the reflective element 17 and the holder 24 are vertically elongated so that their height is greater than their widths. Because the reflective element 17 is relatively long in the vertical direction, no adjustment is needed if drivers of differing height drive the car and typically always a sufficient forward vision field is provided independent on the drivers height. In this embodiment the forward vision mirror 16 is not adjustable.

It is to be appreciated, however, that in an alternative embodiment the forward vision mirror 16 may be adjustable. For example, the forward vision mirror 16 may further include a remotely controlled motor coupled to the reflective element 17 to enable a driver 14 to vary the angle and orientation of the reflective element 17, in a similar manner as currently available with electric rear vision mirrors. Further, if desired the forward vision mirror 16 can also be fitted with additional rounded mirrors, such as convex mirrors, or lenses for extending the forward field of view or enlarging objects in the forward field of view.

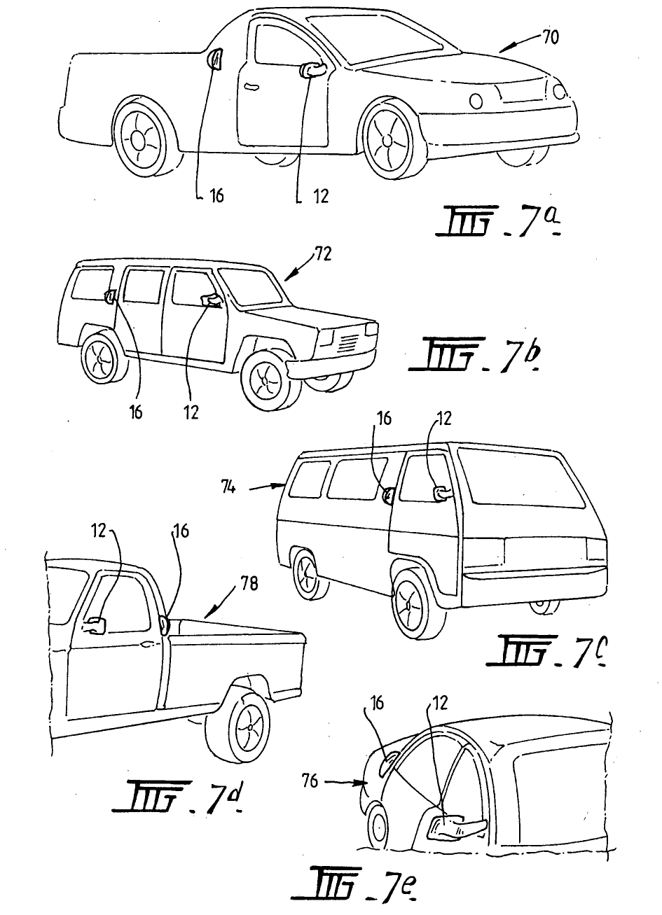

FIG. 7 shows further variations of the forward vision mirror 16 according to embodiments of the present invention. FIG. 7(a) shows a utility vehicle 70 having the forward vision mirror 16 attached to a side portion of the vehicle 70. FIG. 7(b) shows a four-wheel-drive motor vehicle 72 having the forward vision mirror 16 attached to a side portion of the vehicle 72 and FIGS. 74(c) to (e) show a van 74, a sedan 76 and a truck (d) having the forward vision mirror 16 attached to a side portion.

FIG. 8(a) shows an embodiment of the forward vision mirror in more detail. The forward vision mirror 80, suitable for example for mounting to a sedan, comprises in this embodiment a reflective element 82 and a holder 84. The reflective element 82 is set in the holder 84 so that an edge 86 is protruding around the reflective element 82 and which is arranged to reduce or block off reflections form the sun.

FIG. 8(b) shows another embodiment of the forward vision mirror 90 which is in this case narrower than the forward vision mirror 80 and suitable for wider vehicles such as trucks. Similar to the forward vision mirror 80, the forward vision mirror 90 has a reflective element 92, a holder 94, and a protruding edge 96. In this embodiment the holder 94 comprises a slot (not shown) at the protruding edge 96 which is defined by substantially U-shaped portions of the holder 94 and in which the reflective element 92 is positioned.

FIG. 8(c) shows a forward vision mirror 100 according to a further embodiment of the present invention. The forward vision mirror 100 comprises a first holder portion 106 and a second holder portion 104. The first holder portion 106 is holding reflective element 108 and has a first attachment surface 109 that is arranged for attachment to a second attachment surface 110 of the second holder portion 104. In this embodiment the first and second attachment surfaces 109 and 110 are planar. It is to be appreciated that the forward vision mirror 100 and the mount 104 may alternatively form one part. The first holder 104 has a third attachment surface that is arranged to contact a surface of the vehicle 102 which may be curved. In this embodiment the third attachment surface is curved.

It is to be appreciated that the forward vision mirror 16, 80, 90 and 100 may comprise a reflective element comprising any suitable material including mirrored plastics materials such as Perspex, mirrored glass, solid metal, and any substantially unbreakable mirror materials.

Modifications and variations of the present invention that would be obvious to a person of ordinary skill in the art are deemed to be within the scope of the present invention in actual which is to be determined from the above description.

What is claimed is:

1. A forward vision mirror for providing a generally forward view to a driver of a vehicle, the vehicle having a rear vision mirror, the forward vision mirror comprising:
a reflective element,
a first holder portion arranged for holding the reflective element, the first holder portion having a first attachment surface and
a second holder portion having second and third attachment surfaces, the second holder portion being arranged for attachment to the first attachment surface of the first holder portion at the second attachment surface and for attachment to a surface of the vehicle at the third attachment surface in a manner such that the forward vision mirror faces in a forward direction of travel of the vehicle and is positioned in a field of view of the rear vision mirror.

2. The forward vision mirror of claim 1 being arranged for mounting on an external surface of the vehicle.

3. The forward vision mirror of claim 1 wherein the reflective element has an elongated shape and the forward vision mirror is arranged for mounting to the vehicle in a manner such that the direction of elongation is substantially vertical relative to the vehicle.

4. A vision system for a vehicle comprising:
a rear vision mirror providing a generally rearward field of view to a driver of the vehicle; and
the forward vision mirror of claim 1.

5. A vision system for a vehicle comprising:
a rear vision mirror providing a generally rearward field of view to a driver of the vehicle; and
the forward vision mirror of claim 3.

6. A forward vision mirror for providing a generally forward view to a driver of a vehicle, the vehicle having a rear vision mirror and the forward vision mirror comprising:
a reflective element,
a holder for holding the reflective element in a manner such that the forward vision mirror faces in a forward direction of travel of the vehicle and is positioned in a field of view of the rear vision mirror,
wherein the reflective element has a height that is greater than its width when attached to the vehicle.

7. The forward vision mirror of claim 6 being arranged for mounting on an external surface of the vehicle.

8. The forward vision mirror of claim 6 wherein the holder is a fixed holder that is not adjustable.

9. A vision system for a vehicle comprising:
a rear vision mirror providing a generally rearward field of view to a driver of the vehicle; and
the forward vision mirror according to claim 6.

10. A vision system for a vehicle comprising:
a rear vision mirror providing a generally rearward field of view to a driver of the vehicle; and
the forward vision mirror according to claim 8.

11. A vehicle comprising a forward vision mirror for providing a generally forward view to a driver of a vehicle, the vehicle having a rear vision mirror, the forward vision mirror comprising:
a reflective element,
a first holder portion holding the reflective element, the first holder portion having a first attachment surface, and
a second holder portion having second and third attachment surfaces,
wherein the second holder portion is attached to the first attachment surface of the first holder portion at the second attachment surface and is attached to a surface of the vehicle at the third attachment surface in a manner such that the forward vision mirror faces in a forward direction of travel of the vehicle and is positioned in a field of view of the rear vision mirror.

12. The vehicle as claimed in claim 11 wherein the reflective element has an elongated shape and the forward vision mirror is mounted to the vehicle in a manner such that the direction of elongation is substantially vertical relative to the vehicle.

13. A vehicle comprising a forward vision mirror for providing a generally forward view to a driver of a vehicle, the vehicle having a rear vision mirror and the forward vision mirror comprising:
a reflective element,
a holder holding the reflective element on a surface of the vehicle in a manner such that the forward vision mirror faces in a forward direction of travel of the vehicle and is positioned in a field of view of the rear vision mirror,
wherein the reflective element has a height that is greater than its width.

14. The vehicle of claim 13 wherein the holder is a fixed holder that is not adjustable.
